(19) United States
(12) Patent Application Publication
(10) Pub. No.: US 2016/0368747 A1
(43) Pub. Date: Dec. 22, 2016

(54) PALLET TRANSPORTING DEVICE

(71) Applicant: Brian O'Connell, Huntersville, NC (US)

(72) Inventor: Brian O'Connell, Huntersville, NC (US)

(21) Appl. No.: 15/253,349

(22) Filed: Aug. 31, 2016

Related U.S. Application Data
(63) Continuation-in-part of application No. 14/843,701, filed on Sep. 2, 2015, now abandoned.
(60) Provisional application No. 62/044,643, filed on Sep. 2, 2014.

(51) Int. Cl. B66F 9/065; B62B 3/06

(52) U.S. Cl. CPC B66F 9/065; B62B 3/0618

(57) ABSTRACT

In some embodiments, the device may comprise a rocker arm, fist tine, and second tine which may be coupled to a chassis. A first proximal wheel yoke having a first retractable load bearing wheel may be pivotally coupled to the first tine. A first distal wheel yoke having a first retractable counter balance wheel may also be pivotally coupled to the first tine. A first tappet may be coupled to the first proximal wheel yoke, to the first distal wheel yoke, and to the rocker arm. A second proximal wheel yoke having a second retractable load bearing wheel may be pivotally coupled to the second tine. A second distal wheel yoke having a second retractable counter balance wheel may also be pivotally coupled to the second tine. A second tappet may be coupled to the second proximal wheel yoke, to the second distal wheel yoke, and to the rocker arm.

### CROSS REFERENCE TO RELATED APPLICATIONS

This application is a continuation-in-part of U.S. Non-Provisional application Ser. No. 14/843,701, filed on Sep. 2, 2015, entitled “PALLET LIFT”, which claims the benefit of U.S. Provisional Patent Application Ser. No. 62/044,643, filed on Sep. 2, 2014, entitled “IMPROVED PALLET LIFT”, the entire disclosures of which are incorporated by reference herein.

### FIELD OF THE INVENTION

This patent specification relates to the field of pallet trucks. More specifically, this patent specification relates to pallet trucks configured to manipulate a plurality of pallet types including high profile pallets.

### BACKGROUND

Pallets are commonly used to secure durable goods during transport between various locations. Typically, a pallet comprises a square or rectangular load bearing surface or deck configured to receive goods for storage and transport. Sidewalls with ground contacting legs extend vertically below the deck forming a space or cavity suitable to engage various types of pallet transporting equipment such as hand pallet trucks, Walkie Pallet Jacks, forklifts, and the like. Pallet transportation equipment commonly includes two elongated forks known as “tines” which are inserted under the pallet deck and into the pallet cavity to raise the pallet off of the ground for transport.

Recently, pallets with narrow elongated decks and high profile designs have become common place. These high profile pallets may have support decks which are 6 inches or higher above the ground to be transported by custom designed lifts which are costly to own and maintain.

Therefore, a need exists for an effective means to transport pallets, such as high profile design pallets, with a novel custom pallet lifting device.

### BRIEF SUMMARY OF THE INVENTION

A narrow pallet transporting device is provided which may be used to lift, lower, move, or otherwise motivate pallets, such as high profile design pallets. In some embodiments, the device may comprise a rocker arm which may be coupled to a chassis, and the rocker arm may be movable between raised position and a lowered position. A first tine may be coupled to the chassis. A first proximal wheel yoke may be pivotally coupled to the first tine, and the first proximal wheel yoke may comprise a first retractable load bearing wheel. The first proximal wheel yoke may be movable between a retracted position and an extended position. A first distal wheel yoke may also be pivotally coupled to the first tine, and the first distal wheel yoke may comprise a first retractable counter balance wheel. The first distal wheel yoke may also be movable between a retracted position and an extended position. A first tappet may be coupled to the first proximal wheel yoke, to the first distal wheel yoke, and to the rocker arm. The device may further comprise a second tine which may also be coupled to the chassis. A second proximal wheel yoke may be pivotally coupled to the second tine, and the second proximal wheel yoke may comprise a second retractable load bearing wheel. The second proximal wheel yoke may be movable between a retracted position and an extended position. A second distal wheel yoke may also be pivotally coupled to the second tine, and the second distal wheel yoke may comprise a second retractable counter balance wheel. The second distal wheel yoke may also be movable between a retracted position and an extended position. A second tappet may be coupled to the second proximal wheel yoke, to the second distal wheel yoke, and to the rocker arm.

In further embodiments, the device may comprise a first horizontal retractable wheel and second horizontal retractable wheel. The first horizontal retractable wheel may be movable between a first inner position and a second lateral extended position, and the second horizontal retractable wheel may also be movable between a first inner position and a second lateral extended position.

In still further embodiments, the first proximal wheel yoke and first distal wheel yoke may be moved synchronously into the retracted position when the rocker arm is moved into the raised position.

In still further embodiments, the second proximal wheel yoke, and second distal wheel yoke may be moved synchronously into the retracted position when the rocker arm is moved into the raised position.

In yet further embodiments, the first proximal wheel yoke and first distal wheel yoke may be moved synchronously into the extended position when the rocker arm is moved into the lowered position.

In yet further embodiments, the second proximal wheel yoke and second distal wheel yoke may be moved synchronously into the extended position when the rocker arm is moved into the lowered position.

In still further embodiments, the first proximal wheel yoke, first distal wheel yoke, second proximal wheel yoke, and second distal wheel yoke may be moved synchronously into the retracted position when the rocker arm is moved into the raised position, and the first proximal wheel yoke, first distal wheel yoke, second proximal wheel yoke, and second distal wheel yoke may be moved synchronously into the extended position when the rocker arm is moved into the lowered position.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a side elevation view of an elongate side of an example of a narrow pallet transporting device according to various embodiments described herein.

FIG. 2 illustrates a side elevation view of an elongate side of an example of a narrow pallet transporting device according to various embodiments described herein.

FIG. 3 shows a top perspective view of an example of a narrow pallet transporting device according to various embodiments described herein.

FIG. 4 depicts a top perspective view of an example of a narrow pallet transporting device according to various embodiments described herein.

FIG. 5 illustrates a bottom perspective view of an example of a narrow pallet transporting device engaged with a high profile design pallet according to various embodiments described herein.

FIG. 6 shows a rear elevation view of an example of a narrow pallet transporting device according to various embodiments described herein.

FIG. 7 depicts a rear elevation view of an example of a narrow pallet transporting device according to various embodiments described herein.

FIG. 8 illustrates a perspective view of an example of a two wheel hand truck according to various embodiments described herein.

FIG. 9 shows a perspective view of an example of a narrow high profile pallet according to various embodiments described herein.

FIG. 10 depicts a rear elevation view of an example of a narrow pallet transporting device with a close-up view showing the horizontal retractable wheels extended out laterally.

FIG. 11 illustrates a side profile view of a tine of a narrow pallet transporting device with a retractable multi-directional counter balance wheel raised above the ground surface according to various embodiments described herein.

FIG. 12 shows a side profile view of a tine of a narrow pallet transporting device with a retractable multi-directional counter balance wheel in contact with the ground surface according to various embodiments described herein.

FIG. 13 depicts a perspective view of an example of a tappet coupled to a proximal wheel yoke having a retractable load bearing wheel and coupled to a distal wheel yoke having a retractable counter balance wheel with both the proximal wheel yoke and distal wheel yoke in an extended position.

FIG. 14 illustrates a perspective view of an example of a tappet coupled to a proximal wheel yoke having a retractable load bearing wheel and coupled to a distal wheel yoke having a retractable counter balance wheel with both the proximal wheel yoke and distal wheel yoke in a retracted position.

FIG. 15 shows a perspective exploded view of an example of a narrow pallet transporting device according to various embodiments described herein.

FIG. 16 depicts a side elevation view of an example of a tine of narrow pallet transporting device with a distal wheel yoke and a proximal wheel yoke which are both in a retracted position and which are coupled to a rocker arm which is in a raised position.

FIG. 17 illustrates a side elevation view of an example of a tine of narrow pallet transporting device with a distal wheel yoke and a proximal wheel yoke which are both in an extended position and which are coupled to a rocker arm which is in a lowered position.

### LISTING OF FEATURE ELEMENTS IN THE FIGURES

(10) Retractable Counter Balance Wheel
(10A) Retractable Multi-directional Counter Balance Wheel
(11) Retractable Load Bearing Wheel
(12) Fork Tine Handle Slot
(13) Removable Fork Tine Handle
(14) Hand Truck Carrying Slot
(15) Horizontal Retractable Wheels
(16) Chassis
(17) Horizontal Retractable Caster Spring
(18) Horizontal Retractable Caster Mounting Plate
(19) Proximal Wheel Yoke
(20) Distal Wheel Yoke
(21) Proximal Wheel Pin
(22) Distal Wheel Pin
(23) Back Tappet Region
(24) Center Tappet Region
(25) Left Adjoined Tappet
(26) Right Adjoined Tappet
(27) Front Tappet Region
(28) Distal Tappet Hinge Pin
(29) Proximal Fork Frame Hinge
(30) Distal Fork Fame Hinge
(31) Proximal Tappet Hinge
(32) Distal Tappet Hinge
(33) Left Tappet Rod
(34) Right Tappet Rod
(35) Proximal Fork Frame Hinge Pin
(36) Distal Fork Frame Hinge Pin
(37) Ground
(40) Rocker Arm
(41) Tappet 41
(43) Wheel Well
(44) Hydraulic Pump
(45) Access Housing
(46) Access Panel
(47) Distribution Plate
(48) User Control Inputs
(49) Handles
(50) Tappet Yoke
(60) Two Wheel Hand Truck
(61) Two Wheel Hand Truck Nose Plate
(91) Raised Position
(92) Lowered Position
(95) Retracted Position
(96) Extended Position
(98) First Inner Position
(99) Second Lateral Extended Position
(100) High Profile Design Pallet
(300) Narrow Pallet Transporting Device
(301) Tine of Narrow Pallet Transporting Device

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

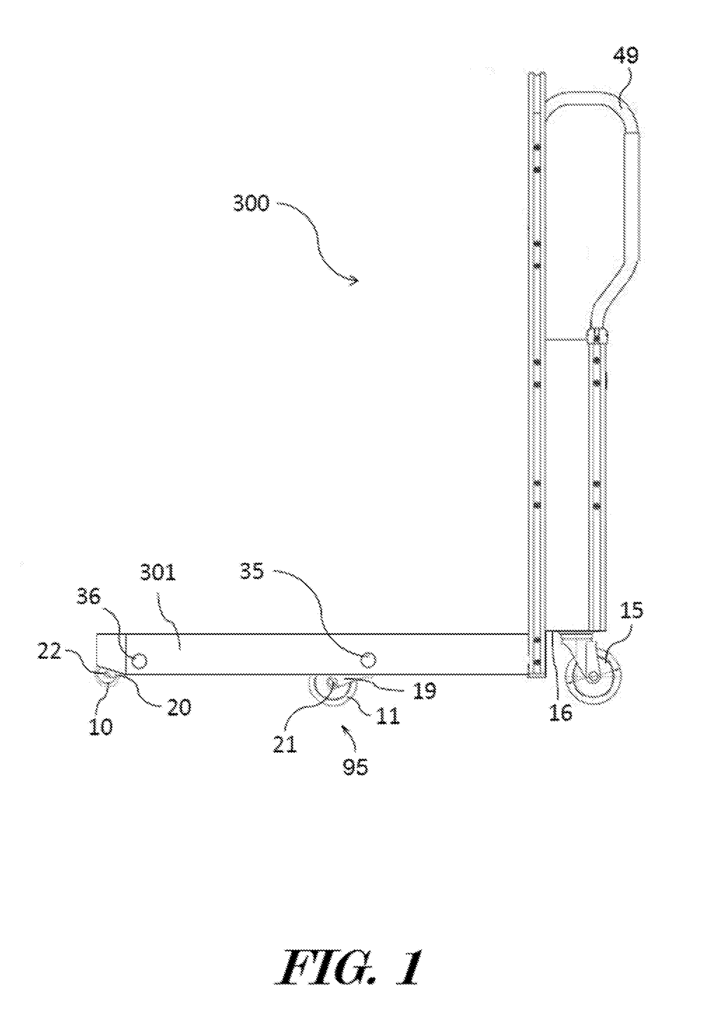

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new pallet manipulation and lifting device is discussed herein. Additionally, new high profile design pallets, such as that taught in U.S. patent application Ser. No. 14/218,161 filed on Mar. 18 2014 and titled “Improved Pallet with Tine Support Elements”, the entire contents of which are incorporated herein by reference and narrow pallet transporting devices are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

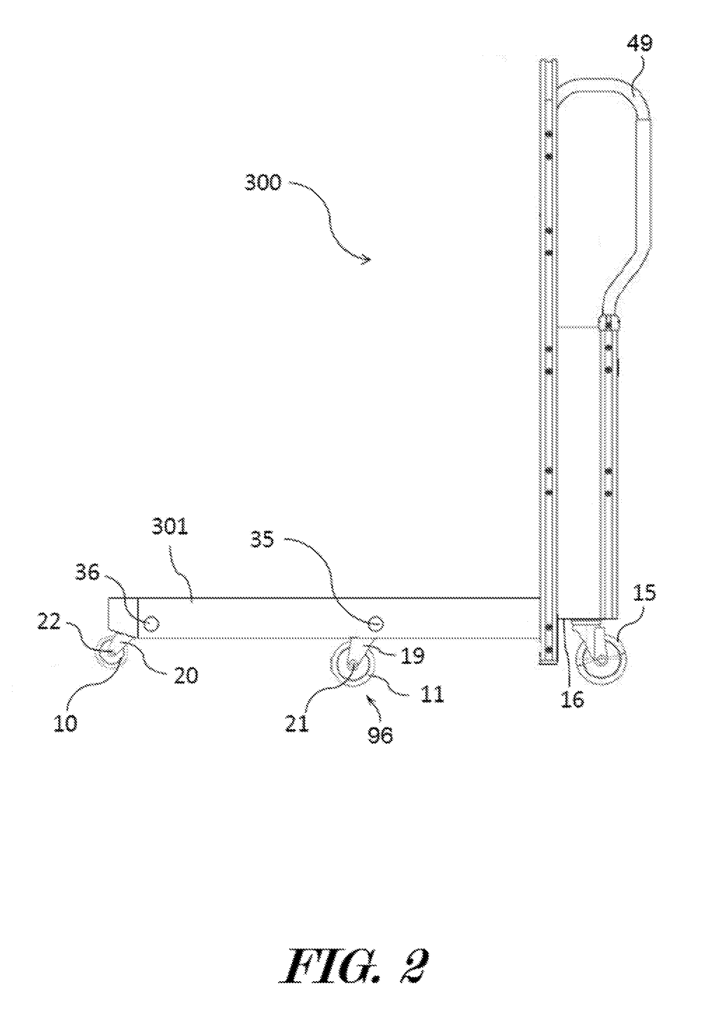

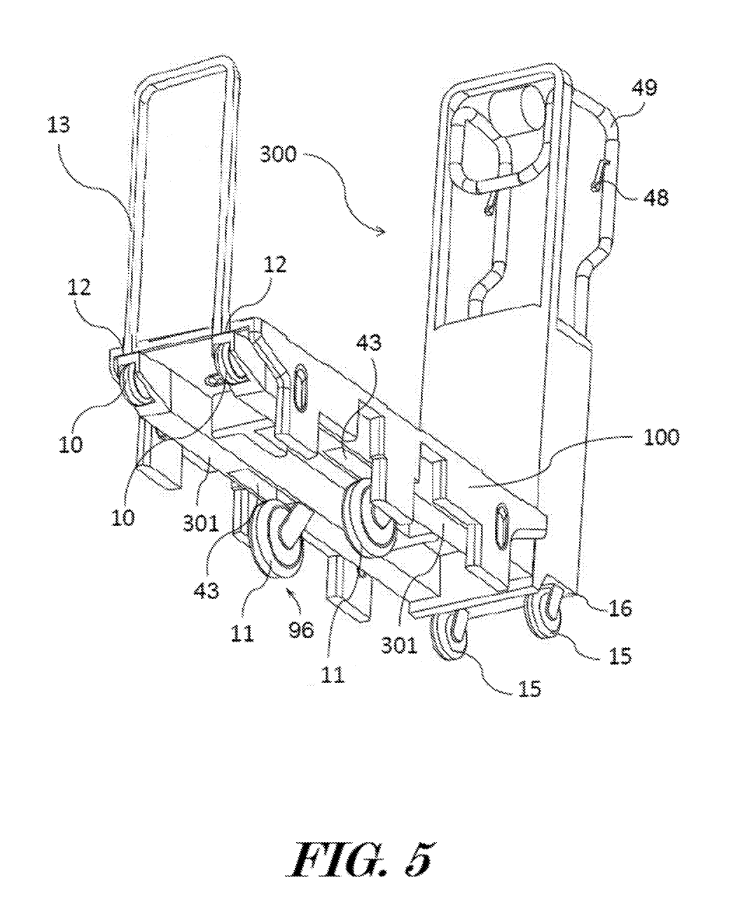

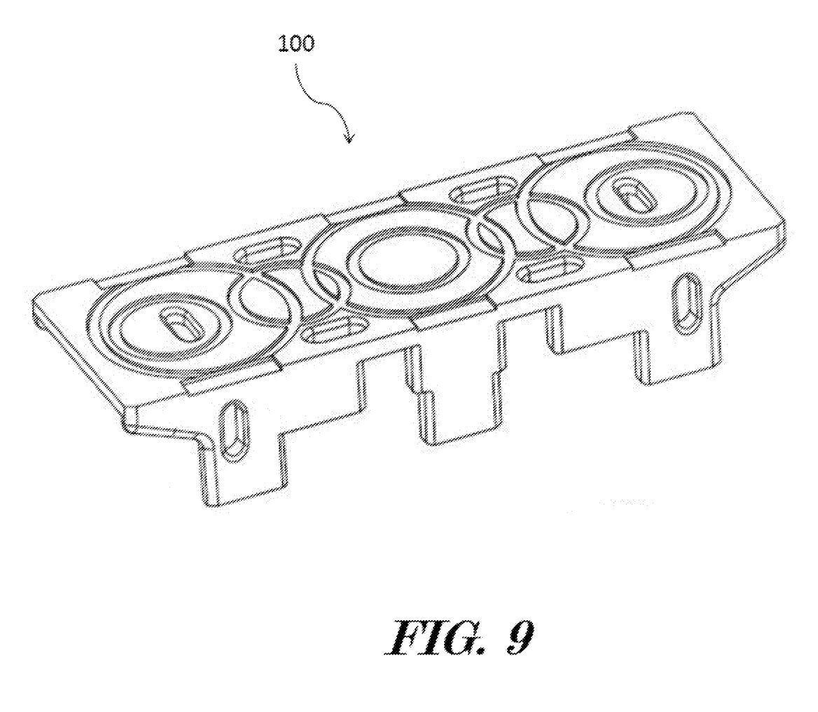

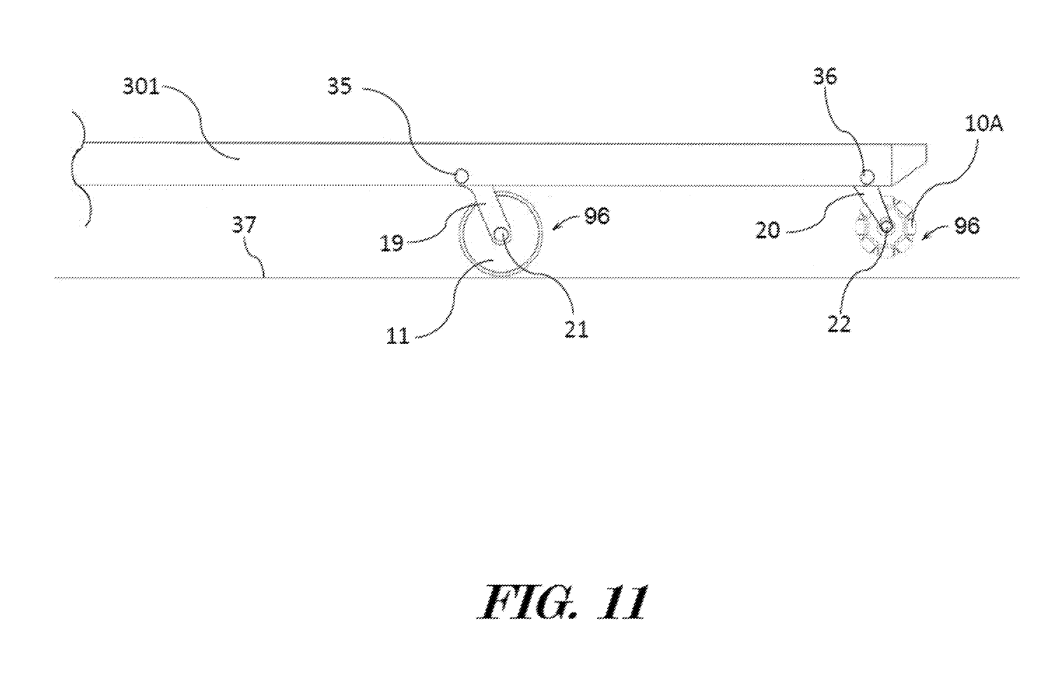

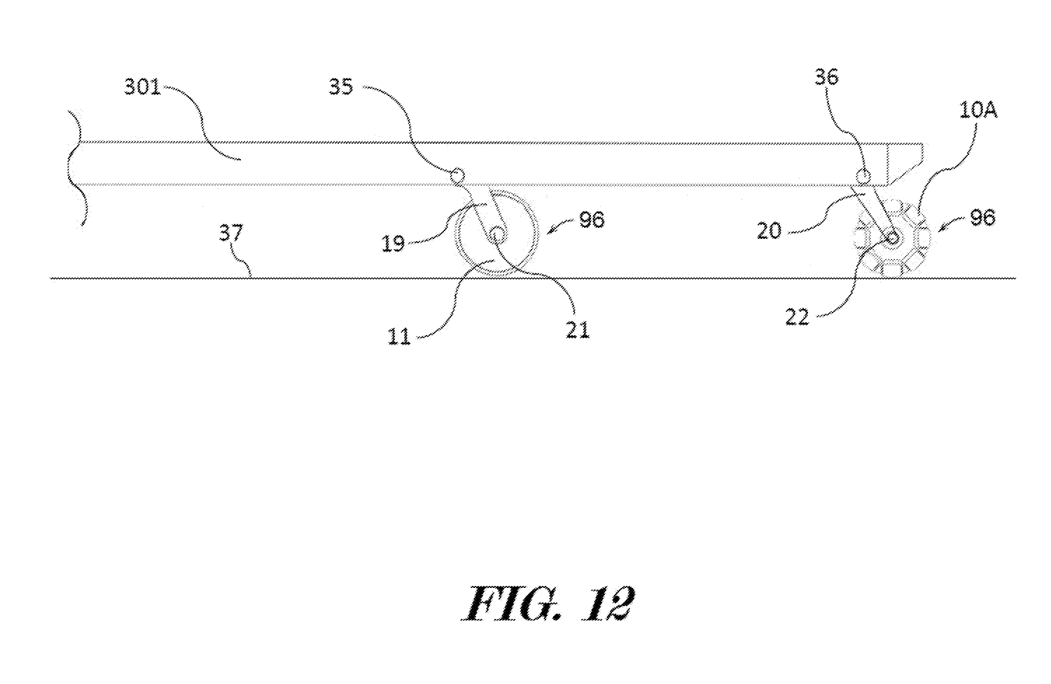

The present invention will now be described by example and through referencing the appended figures representing preferred and alternative embodiments. FIG. 1 and FIG. 2 illustrate an example of an improved narrow pallet transporting device (“the improved pallet lift device” or “the device”) 300 according to various embodiments of the present invention. The device 300 may comprise two or more tines 301 which may be used to engage with or otherwise interact with pallets, such as high profile design pallets 100 (FIGS. 5 and 9), and the device 300 may have one or more wheels 10,11,15 for movement along the ground 37 (FIGS. 11 and 12).

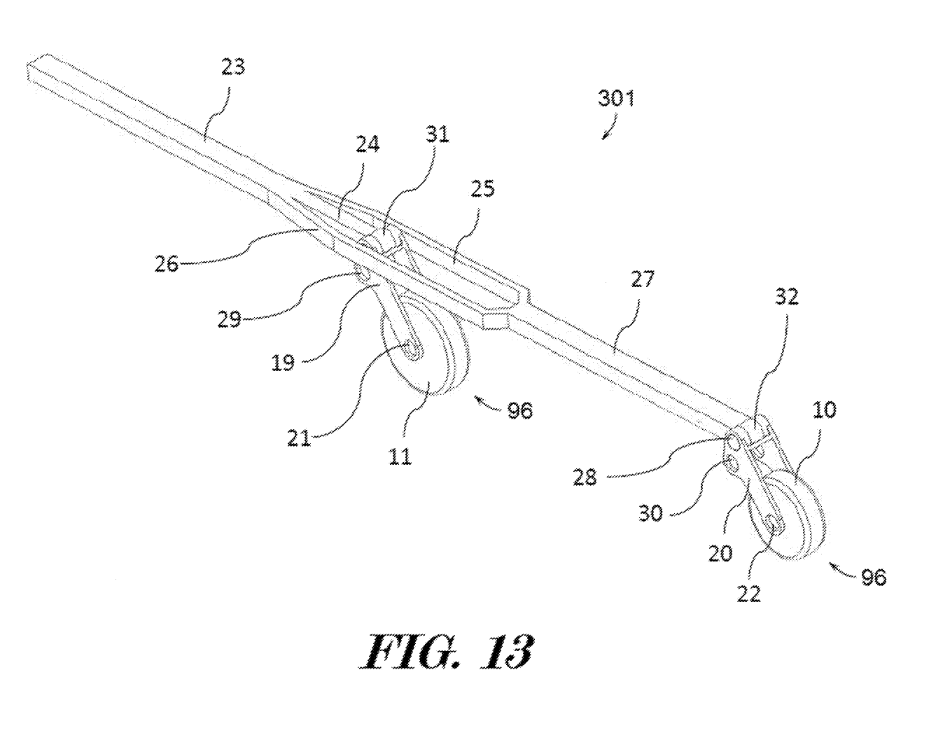

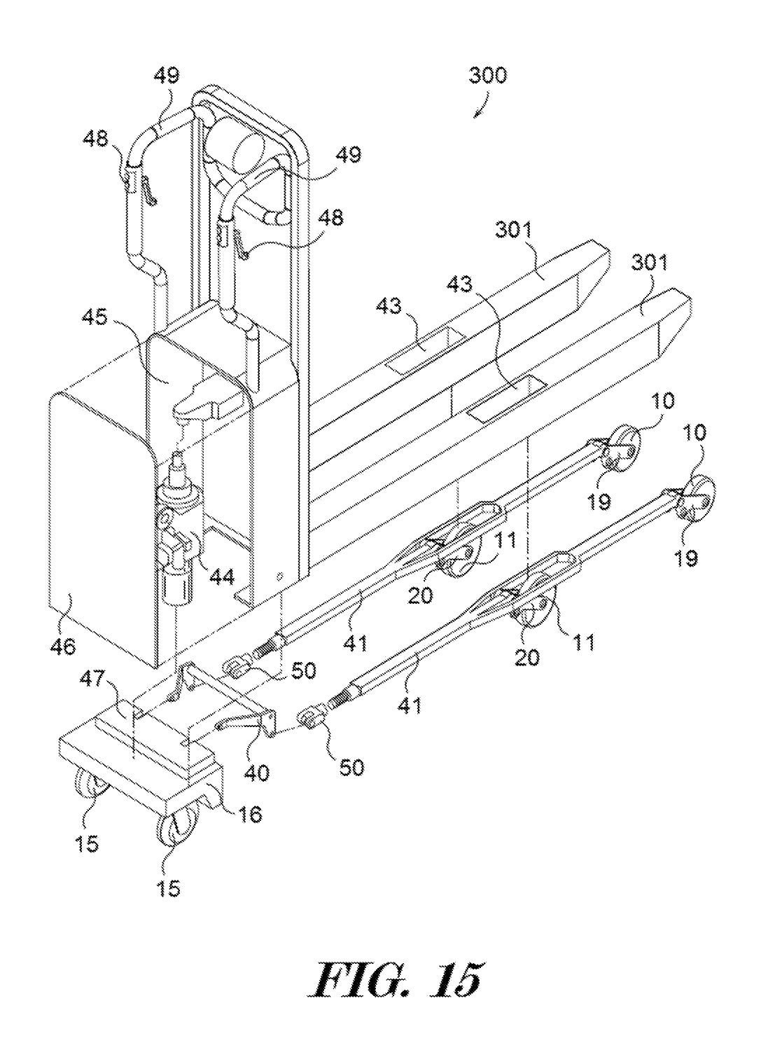

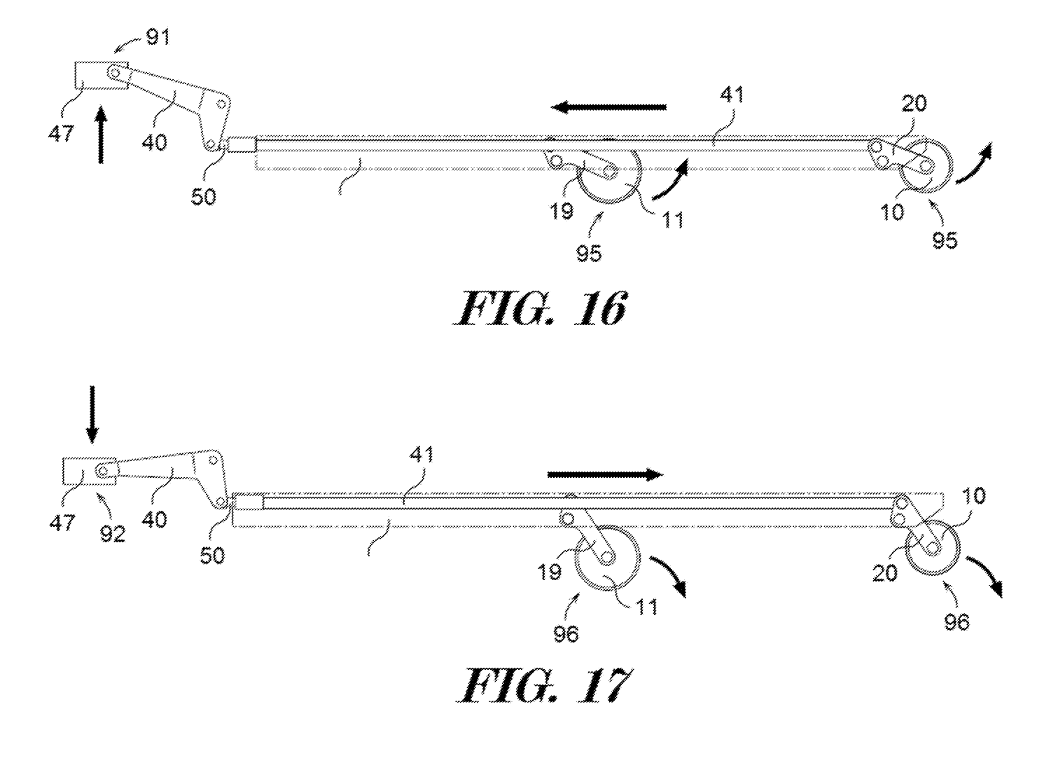

In some embodiments, the device 300 may comprise a chassis 16 and a rocker arm 40 (FIGS. 15-17) which may be coupled to the chassis 16, and the rocker arm 40 may be movable between raised position 91 (FIG. 16) and a lowered position 92 (FIG. 17). One or more horizontal retractable wheels 15 may also be coupled to the chassis 16. A first tine 301 may be coupled to the chassis 16. A first proximal wheel yoke 19 may be pivotally coupled to the first tine 301, and the first proximal wheel yoke 19 may comprise a first retractable load bearing wheel 11. The first proximal wheel yoke 19 may be movable between a retracted position 95 (FIGS. 1, 3, 4, 14, and 16) and an extended position 96 (FIGS. 2, 5, 11-13, and 17). A first distal wheel yoke 20 may also be pivotally coupled to the first tine 301, and the first distal wheel yoke 20 may comprise a first retractable counter balance wheel 10. The first distal wheel yoke 20 may also be movable between a retracted position 95 and an extended position 96. A first tappet 41 (FIGS. 13-17) may be coupled to the first proximal wheel yoke 19, to the first distal wheel yoke 20, and to the rocker arm 40. The device 300 may further comprise a second tine 301 which may also be coupled to the chassis 16. A second proximal wheel yoke 19 may be pivotally coupled to the second tine 301, and the second proximal wheel yoke 19 may comprise a second retractable load bearing wheel 11. The second proximal wheel yoke 19 may be movable between a retracted position 95 and an extended position 96. A second distal wheel yoke 20 may also be pivotally coupled to the second tine 301, and the second distal wheel yoke 20 may comprise a second retractable counter balance wheel 10. The second distal wheel yoke 20 may also be movable between a retracted position 95 and an extended position 96. A second tappet 41 may be coupled to the second proximal wheel yoke 19, to the second distal wheel yoke 20, and to the rocker arm 40.

In further embodiments, the proximal wheel yokes 19 and distal wheel yokes 20 of one or more tines 301 may be moved into a retracted position 95 (FIGS. 1, 3, 4, 14, and 16) when the rocker arm 40 is moved into the raised position 91 (FIG. 16). In still further embodiments, the proximal wheel yokes 19 and distal wheel yokes 20 of one or more tines 301 may be moved into the extended position 96 (FIGS. 2, 5, 11-13, 15, and 17) when the rocker arm 40 is moved into the lowered position 92 (FIG. 17). In this manner, by moving the wheel yokes 19, 20, the retractable counter balance wheels 10 and retractable load bearing wheels 11 may be moved towards and away from the tines 301 thereby lowering and lifting the tines 301 towards and away from the ground 37 (FIGS. 11 and 12), respectively. The raising and lowering of the tines 301 may enable the device 300 to raise and lower pallets towards and away from the ground 37 while the wheels 10, 11, 15, may enable the device 300 to move freely over the ground 37. When the tines 301 are placed under a pallet, such as a high profile design pallet 100, and lifted away from the ground 37, the pallet may be lifted away from the ground 37 by the tines 301. Conversely, when the tines 301 supporting a pallet over and away from the ground 37, such as a high profile design pallet 100, and lowered towards the ground 37, the pallet may be lowered towards the ground 37 by the tines 301.

As perhaps best shown in FIGS. 1-5, and 15, the device 300 may comprise one or more, such as two, tines 301 which may be coupled to a chassis 16 having one or more, such as two, horizontal retractable wheels 15. Preferably, the tines 301 may be movably coupled to the chassis 16 thereby allowing the tines 301 to be moved relative to the chassis 16. Each tine 301 may comprise one or more retractable counter balance wheels 10 and/or retractable load bearings wheel 11. In some embodiments, each tine 301 may comprise a distal wheel yoke 20 with a retractable counter balance wheel 10 coupled to the end of each tine 301 that is distal from the chassis 16. In further embodiments, each tine 301 may comprise a proximal wheel yoke 19 which may be coupled to the each tine 301 medially between the chassis 16 and the distal wheel yoke 20 and retractable counter balance wheel 10.

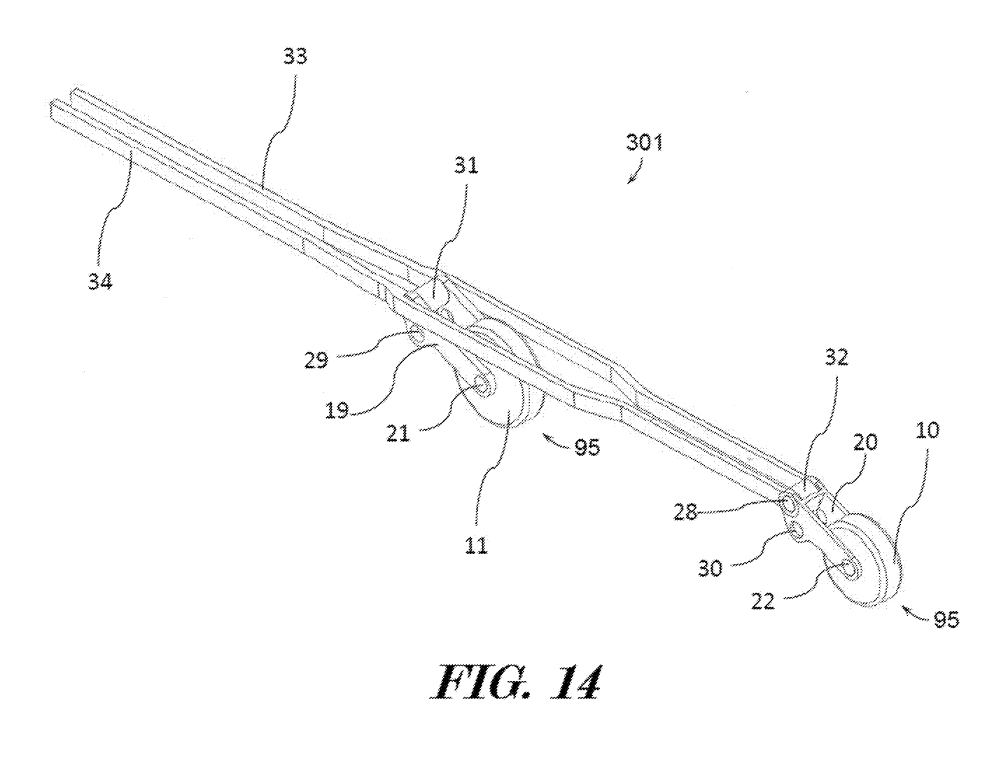

Each proximal wheel yoke 19 may be movably coupled to its respective tine 301 and also movably coupled to its respective tappet 40. In some embodiments, a proximal wheel yoke 19 may be movably coupled to its respective tine 301 with a proximal fork frame hinge 29 (FIGS. 13 and 14). A proximal fork frame hinge 29 may comprise any type of hinge, such as a butt hinge, piano hinge, barrel hinge, butt/Mortise hinge, case hinge, flag hinge, strap hinge, H hinge, HL hinge, piano hinge, butterfly hinge, flush hinge, barrel hinge, concealed hinge, continuous hinge, T-hinge, strap hinge, double-acting hinge, Soss hinge, counterflap hinge, flush hinge, coach hinge, rising butt hinge, double action spring hinge, tee hinge, friction hinge, security hinge, cranked hinge or stormproof hinge, lift-off hinge, self closing or self positioning hinge, flexible material hinge, or any other type or style of hinge which may be enable a proximal wheel yoke 19 to be movably coupled to a tine 301. In further embodiments, a proximal wheel yoke 19 may be movably coupled to its respective tine 301 with a proximal fork frame hinge pin 35 which may be inserted through portions of the proximal wheel yoke 19 and the tine 301 and which may movably couple the proximal wheel yoke 19 and the tine 301 together.

In some embodiments, a proximal wheel yoke 19 may be movably coupled to its respective tappet 41 with a proximal tappet hinge 31 (FIGS. 13 and 14). Similar to a proximal fork frame hinge 29, a proximal tappet hinge 31 may comprise any type of hinge which may be enable a proximal wheel yoke 19 to be movably coupled to a tappet 41. In further embodiments, a proximal wheel yoke 19 may be movably coupled to its respective tappet 41 with a hinge pin, similar to a proximal fork frame hinge pin 35, which may be inserted through portions of the proximal wheel yoke 19 and the tappet 41 and which may movably couple the proximal wheel yoke 19 and the tappet 41 together.

Each distal wheel yoke 20 may be movably coupled to its respective tine 301 and also movably coupled to its respective tappet 40. In some embodiments, a distal wheel yoke 20 may be movably coupled to its respective tine 301 with a distal fork frame hinge 30 (FIGS. 13 and 14). A distal fork frame hinge 30 may comprise any type of hinge which may be enable a distal wheel yoke 20 to be movably coupled to a tine 301. In further embodiments, a distal wheel yoke 20 may be movably coupled to its respective tine 301 with a distal fork frame hinge pin 36 which may be inserted through portions of the distal wheel yoke 20 and the tine 301 and which may movably couple the distal wheel yoke 20 and the tine 301 together.

In some embodiments, a distal wheel yoke 20, may be movably coupled to its respective tappet 41 with a distal tappet hinge 32 (FIGS. 13 and 14). Similar to a distal fork frame hinge 30, a distal tappet hinge 32 may comprise any type of hinge which may be enable a distal wheel yoke 20 to be movably coupled to a tappet 41. In further embodiments, a distal wheel yoke 20 may be movably coupled to its respective tappet 41 with a hinge pin, similar to a distal fork frame hinge pin 36, which may be inserted through portions of the distal wheel yoke 20 and the tappet 41 and which may movably couple the distal wheel yoke 20 and the tappet 41 together.

Each proximal wheel yoke 19 may comprise a retractable load bearing wheel 11, and each distal wheel yoke 20 may comprise a retractable counter balance wheel 10. The retractable load bearing wheels 11 may be positioned anywhere on the tines 301, such as approximately in the middle or medially on a tine 301, to provide a tight turning radius for the device 300 where as the retractable counter balance wheel 10 provides a support mechanism if the narrow pallet transporting device 300 were to tip forward.

In some embodiments, a retractable load bearing wheel 11 may be movably coupled to a proximal wheel yoke 19 with a proximal wheel pin 21 (FIGS. 13 and 14) which may be inserted through portions of the proximal wheel yoke 19 and the retractable load bearing wheel 11 thereby movably coupling the proximal wheel yoke 19 and the retractable load bearing wheel 11 together. In other embodiments, a retractable load bearing wheel 11 may be movably coupled to a proximal wheel yoke 19 with any other suitable coupling which allows movement of the retractable load bearing wheel 11 while it is coupled to the proximal wheel yoke 19.

In some embodiments, a retractable counter balance wheel 10 may be movably coupled to a distal wheel yoke 20 with a distal wheel pin 22 (FIGS. 13 and 14) which may be inserted through portions of the distal wheel yoke 20 and the retractable counter balance wheel 10 thereby movably coupling the distal wheel yoke 20 and the retractable counter balance wheel 10 together. In other embodiments, a retractable counter balance wheel 10 may be movably coupled to a distal wheel yoke 20 with any other suitable coupling which allows movement of the retractable counter balance wheel 10 while it is coupled to the distal wheel yoke 20.

FIG. 13 depicts a perspective view of an example of a tappet 41 with both the proximal wheel yoke 19 and distal wheel yoke 20 in an extended position 96, while FIG. 14 illustrates a perspective view of an example of a tappet 41 with both the proximal wheel yoke 19 and distal wheel yoke 20 in a retracted position 96 according to various embodiments described herein. A tappet 41 may be unitary or may be composed of one or more sub assemblies, such as a left tappet rod 33 and a right tappet rod 34 which may be coupled together to form a single tappet 41. Additionally, a tappet 41 may comprise one or more regions which may be positioned within, under, adjacent, or anywhere else in relation to the tine 301 to which the tappet 41 is coupled. For example, a tappet 41 may comprise a back tappet region 23 which may be coupled to a rocker arm 40, such as with a tappet yoke 50 (FIGS. 15-17), a center tappet region 24, which may be coupled to a proximal wheel yoke 19, and a front tappet region 27, which may be coupled to a distal wheel yoke 20. Optionally, a tappet 41 may also comprise a left adjoined tappet 25 and/or a right adjoined tappet 26 which may be separated to allow portions of a proximal wheel yoke 19 to be positioned between the left adjoined tappet 25 and right adjoined tappet 26 such as when the proximal wheel yoke 19 is in the retracted position 95.

In some embodiments, one or more retractable counter balance wheels 10 and/or one or more retractable load bearing wheel 11 may be a multi-directional wheel. A multi-directional wheel, sometimes called an Omni wheel or poly wheel, similar to Mecanum wheel, is a wheel with small discs around the circumference which are perpendicular to the turning direction. The effect is that the wheel can be driven with full force, but will also slide laterally with great ease. These wheels are often employed in holonomic drive systems. In preferred embodiments, the device 300 may comprise two first retractable counter balance wheels 10 so that the first retractable counter balance wheel 10 may be a first retractable multi-directional counter balance wheel 10A, and the second retractable counter balance wheel 10 may be a second retractable multi-directional counter balance wheel 10A as shown in FIGS. 11 and 12.

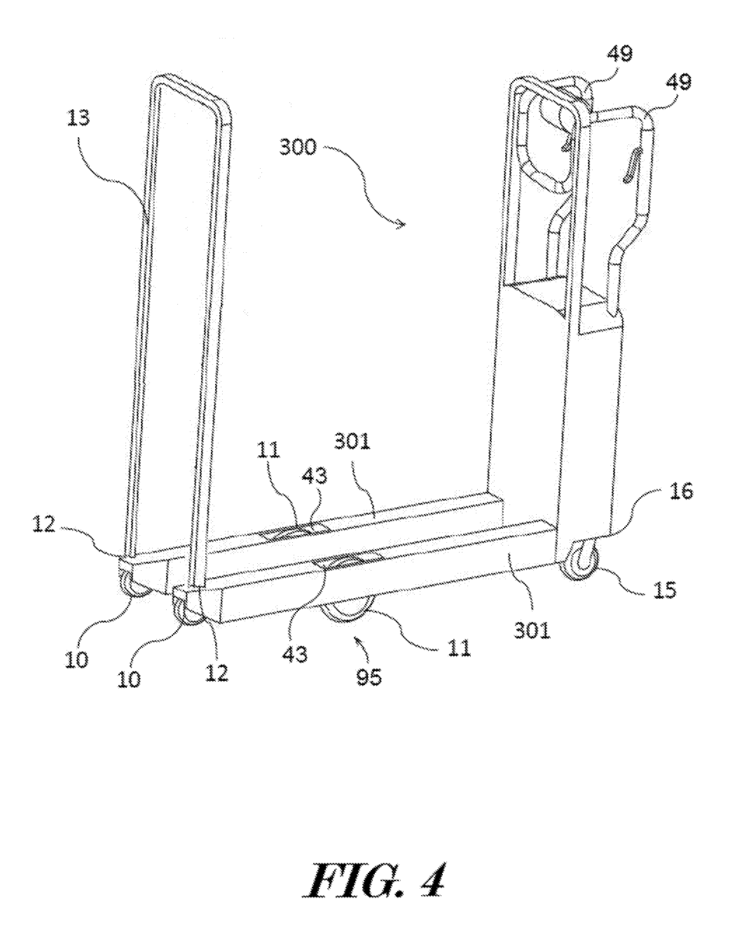

Referring now to FIGS. 4, 5, and 15, in some embodiments, the device 300 may comprise one or more wheel wells 43 which may be positioned anywhere on a tine 301. A wheel well 43 may comprise a recess or cavity which may be formed into a tine 301 and which may be shaped and sized to receive all or portions of a retractable counter balance wheel 10 or a retractable load bearing wheel 11. In further embodiments, all or a portion of a retractable load bearing wheel 11 and its respective proximal wheel yoke 19 may be received in a wheel well 43 when the retractable load bearing wheel 11 and its respective proximal wheel yoke 19 are in the retracted position 95 (FIGS. 1, 3, 4, 14, and 16). In still further embodiments, all or a portion of a retractable counter balance wheel 10, 10A, and its respective distal wheel yoke 20 may be received in a wheel well 43 when the retractable counter balance wheel 10, 10A, and its respective distal wheel yoke 20 are in the retracted position 95. Optionally, a wheel well 43 may pass completely through a tine 301, such as show by the retractable load bearing wheel 11 occupying wheel wells 43, or a wheel well 43 may not pass completely through a tine 301 so as to form a recess in the tine 301, such as show by the retractable counter balance wheel 10, 10A, occupying wheel wells 43.

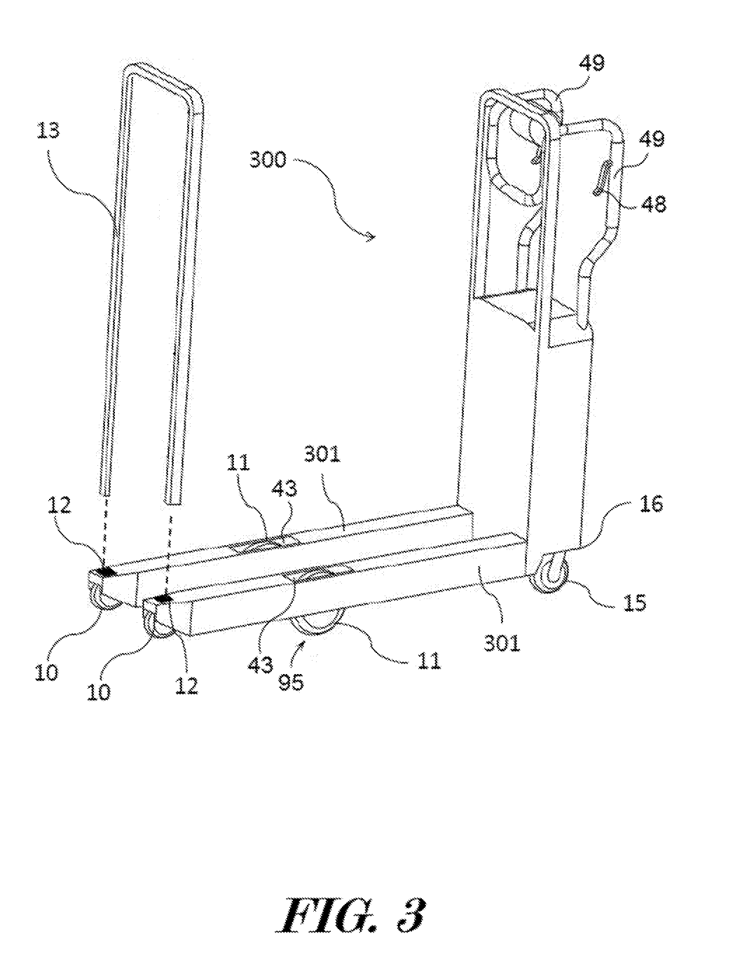

In preferred embodiments, FIG. 3 shows the device 300 with a removable fork tine handle 13 that may be removably coupled to one or more tines 301 of the narrow pallet transporting device 300. A fork tine handle 13 may be of any shape and size that is configured to form a suitable gripping area for a user to manipulate in order to facilitate the manipulation of the distal end, the end farthest from the chassis 16, of the device 300. In some embodiments, a fork tine handle 13 may be removably coupled to one or more tines 301 by inserting a portion of the fork tine handle 13 into each tine 301, such as into a fork tine handle slot 12 on each tine 301. In other embodiments, a fork tine handle 13 may be removably coupled to one or more tines 301 by any other suitable removable or temporary coupling method. FIG. 4 show the removable fork tine handle 13 inserted into the fork tine handle slots 12 located at the distal end of each tine 301 of the narrow pallet transporting device 300. As used herein the term “slot” may include grooves or apertures of any suitable size or dimension. For example, the slot may be round, square, rectangular, triangular, or the like.

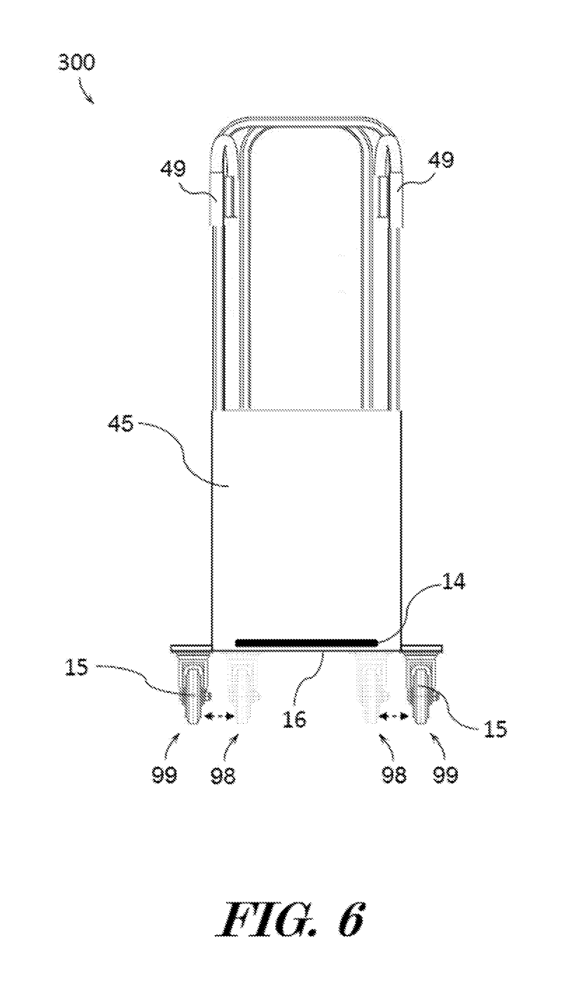

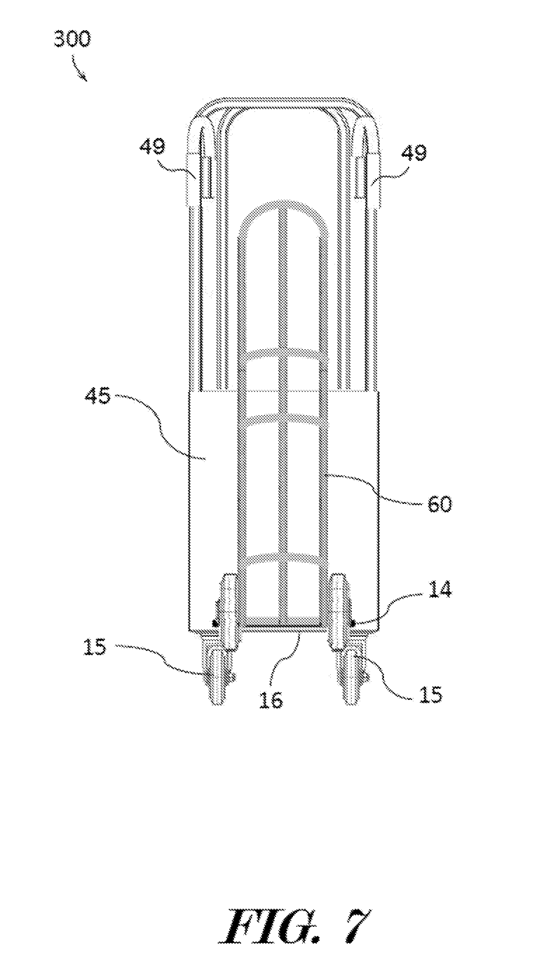

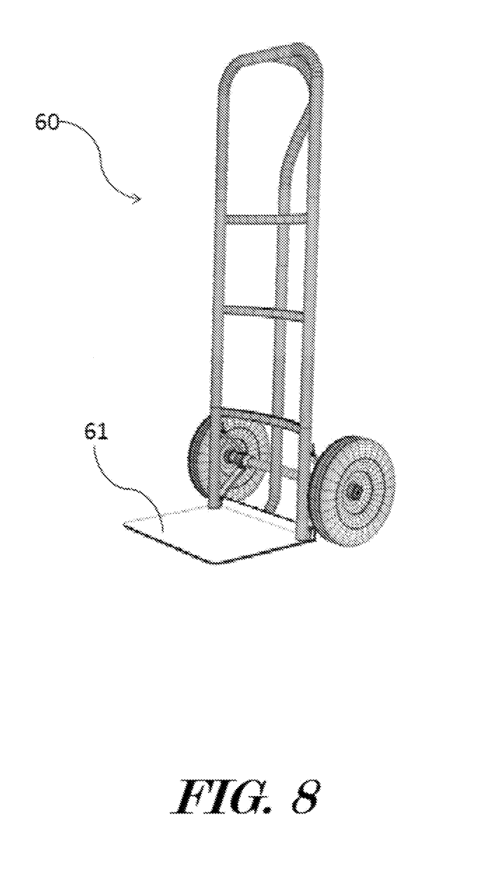

Turning now to FIGS. 6-8, in some embodiments, the device 300 may be configured to engage or receive a two wheel hand truck 60 or dolly so that the two wheel hand truck 60 may be manipulated as a single unit. In further embodiments, the device 300 may have a hand truck carrying slot 14 which is shaped to receive a portion of the two wheel hand truck nose plate 61 so that the two wheel hand truck nose plate 61 can be inserted into the had truck carrying slot 14 for easy transport of a two wheel hand truck 60. FIG. 7 shows the two wheel hand truck nose plate 61 inserted into the hand truck carrying slot 14 of the narrow pallet transporting device 300.

In preferred embodiments, FIG. 6 shows a rear elevation view of the narrow pallet transporting device 300. In this example, the device 300 comprises two horizontal retractable wheels 15, such as a first horizontal retractable wheel 15 and a second horizontal retractable wheel 15, which provide a wider wheel base when needed. The horizontal retractable wheels 15 may be coupled to the chassis 16 and may be used in conjunction with one or more retractable counter balance wheels 10, 10A, and/or retractable load bearing wheels 11 in order to move the device 300 across the ground 37. Optionally, a horizontal retractable wheel 15 may comprise a caster type wheel, a multi-directional type wheel, any other type of wheel, tread, track, or any other suitable movable conveyance.

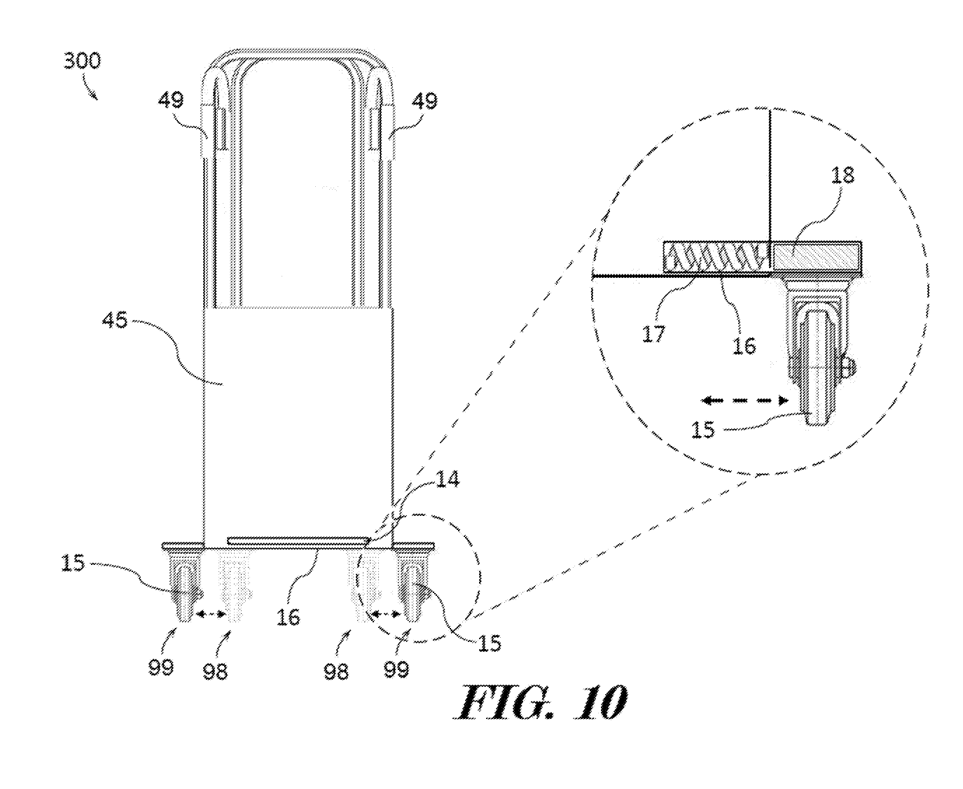

In preferred embodiments, FIG. 10 shows a rear elevation view of the narrow pallet transporting device 300. In this example close-up partial cross sectional view of the horizontal retractable wheels 15 shows how the horizontal retractable caster mounting plate 18 engages the horizontal retractable caster spring 17 to position the horizontal retractable wheels 15 between a first inner position 98, in which the horizontal retractable wheels 15 are relatively closer to each other, and a second lateral extended position 99, in which the horizontal retractable wheels 15 are relatively farther apart from each other. In further preferred embodiments, the device 300 may comprise a horizontal retractable caster spring 17 and the horizontal retractable caster spring 17 may be operable to position the first horizontal retractable wheel 15 and/or second horizontal retractable wheel 15 between a first inner position 98 and a second lateral extended position 99. In still further embodiments, the device 300 may comprise one or more horizontal retractable caster springs 17 and the horizontal retractable caster spring 17 may be operable to position both the first horizontal retractable wheel 15 and the second horizontal retractable wheel 15 between a first inner position 98 and a second lateral extended position 99.

In some embodiments, horizontal retractable caster mounting plate 18 may be configured to slidably engage inside a track or slot within the bottom ground facing side of the lift chassis 16. As used herein the term “horizontal caster spring” 17 may include hydraulics, compression cylinders, air bladders, actuators, etc. of any suitable size or dimension which may be used to motivate a wheel or other conveyance, such as a horizontal retractable wheel 15, into and between a first inner position 98 and a second lateral extended position 99.

In preferred embodiments, the device 300 may comprise a first horizontal retractable wheel 15 which may be movable between a first inner position 98 and a second lateral extended position 99, and a second horizontal retractable wheel 15 which may be movable between a first inner position 98 and a second lateral extended position 99. In other embodiments, the device 300 may comprise one, three, four, or more horizontal retractable wheels 15 and one or more of the horizontal retractable wheels 15 may be movable between a first inner position 98 and a second lateral extended position 99.

Referring to FIGS. 15-17, in some embodiments, the device 300 may comprise a pump such as a hydraulic pump 44 which may be operably coupled to the rocker arm 40. In some embodiments, a hydraulic pump 44 may be a manually operated hydraulic jack or a manually operated pneumatic jack such as which may be operated by pumping a handle 49. In other embodiments, a hydraulic pump 44 may be a manually operated hydraulic jack or a manually operated pneumatic jack such as which may be operated by an electric motor or other type of motor. In further embodiments, the hydraulic pump 44 may be disposed within the chassis 16, such as within an access housing 45 and an access panel 46, and operably coupled to the rocker arm 40 via a distribution plate 47. For example, the hydraulic pump 44 may be operably coupled to the distribution plate 47 and the distribution plate 47 may also be operably coupled to the rocker arm 40 so that movement of one of these elements may result in movement of the other elements.

Movement of the rocker arm 40 may result in movement of one or more tappets 41 which may be coupled to the rocker arm 40. In some embodiments, each tappet 41 may be coupled to the rocker arm 40 with a tappet yoke 50 (FIG. 15) and pivot pin which may provide a movable coupling. In other embodiments, each tappet 41 may be coupled to the rocker arm 40 with any other suitable movable or non-movable coupling method. The movement of the tappets 41 may cause one or more of the wheel yokes 19, 20, to pivot, rotate, or otherwise move towards and away from the tine 301 to which they are coupled. For example, the first proximal wheel yoke 19 and second proximal wheel yoke 19 may be moved into the extended position 96 when the rocker arm 40 is moved into the lowered position 92. In another example, the first distal wheel yoke 20 and second distal wheel yoke 20 may be moved into the extended position 96 when the rocker arm 40 is moved into the lowered position 92. In some embodiments, the hydraulic pump 44 may motivate the distribution plate 47 down, which in turn motivates the rocker arm 40 into a lowered position 92, which in turn motivates the one or more tappets 41 which are coupled to the rocker arm 40, which in turn motivates a distal wheel yoke 20, and its respective retractable counter balance wheel 10, 10A, and a proximal wheel yoke 19, and its respective retractable load bearing wheel 11, into the extended position 96. In further embodiments, the hydraulic pump 44 may motivate the distribution plate 47 up, which in turn motivates the rocker arm 40 into a raised position 91, which in turn motivates the one or more tappets 41 which are coupled to the rocker arm 40, which in turn motivates a distal wheel yoke 20, and its respective retractable counter balance wheel 10, 10A, and a proximal wheel yoke 19, and its respective retractable load bearing wheel 11, into the retracted position 95.

In further preferred embodiments, the hydraulic pump 44 may comprise or be an electrically operated hydraulic pump 44 (i.e. an electric hydraulic pump) which may be configured to motivate the rocker arm 40 when electric power is supplied to the hydraulic pump 44 such as which may be controlled by one or more user control inputs 48 which may be coupled to the chassis 16, such as by way of one or more handles 49, which may be manipulated by a user to move and control the device 300. Optionally, the device 300 may comprise a battery, fuel cell, engine, or the like which may be configured to provide electric power to an electrically operated hydraulic pump 44 and/or to one or more user control inputs 48.

While some materials have been provided, in other embodiments, the elements that comprise the device 300 such as the tines 301, chassis 16, wheels 10, 10A, 11, 15, tappet 41, optional rocker arm 40, optional access housing 45, optional access panel 46, and/or any other element discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 300 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 300 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 300 may be coupled by being one of connected to and integrally formed with another element of the device 300.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A transporting device, the device comprising:
a chassis;
a rocker arm coupled to the chassis, wherein the rocker arm is movable between raised position and a lowered position;
a first tine coupled to the chassis;
a first proximal wheel yoke movable between a retracted position and an extended position, wherein the first proximal wheel yoke is pivotally coupled to the first tine, and wherein the first proximal wheel yoke comprises a first retractable load bearing wheel;
a first distal wheel yoke movable between a retracted position and an extended position, wherein the first distal wheel yoke is pivotally coupled to the first tine, and wherein the first distal wheel yoke comprises a first retractable counter balance wheel;
a first tappet coupled to the first proximal wheel yoke, to the first distal wheel yoke, and to the rocker arm;
a second tine coupled to the chassis;
a second proximal wheel yoke movable between a retracted position and an extended position, wherein the second proximal wheel yoke is pivotally coupled to the second tine, wherein the second proximal wheel yoke comprises a second retractable load bearing wheel;
a second distal wheel yoke movable between a retracted position and an extended position, wherein the second distal wheel yoke is pivotally coupled to the second tine, wherein the second distal wheel yoke comprises a second retractable counter balance wheel; and
a second tappet coupled to the second proximal wheel yoke, to the second distal wheel yoke, and to the rocker arm.

2. The device of claim 1, wherein the first proximal wheel yoke and first distal wheel yoke are moved into the retracted position when the rocker arm is moved into the raised position.

3. The device of claim 1, wherein the second proximal wheel yoke and second distal wheel yoke are moved into the extended position when the rocker arm is moved into the lowered position.

4. The device of claim 1, further comprising a first horizontal retractable wheel and second horizontal retractable wheel.

5. The device of claim 4, wherein the first horizontal retractable wheel is movable between a first inner position and a second lateral extended position, and wherein the second horizontal retractable wheel is movable between a first inner position and a second lateral extended position.

6. The device of claim 4, further comprising a horizontal retractable caster spring, wherein the first horizontal retractable wheel is movable between a first inner position and a second lateral extended position, wherein the second horizontal retractable wheel is movable between a first inner position and a second lateral extended position, and wherein the horizontal retractable caster spring is operable to position the both the first and second horizontal retractable wheels between a first inner position and a second lateral extended position.

7. The device of claim 1, wherein the first retractable counter balance wheel is a first retractable multi-directional counter balance wheel, and wherein the second retractable counter balance wheel is a second retractable multi-directional counter balance wheel.

8. The device of claim 1, comprising a hydraulic pump operably coupled to the rocker arm.

9. The device of claim 8, wherein the hydraulic pump is an electrically operated hydraulic pump.

10. The device of claim 1, wherein the first proximal wheel yoke is coupled to the first tine medially between the chassis and the first distal wheel yoke, and wherein the second proximal wheel yoke is coupled to the second tine medially between the chassis and the second distal wheel yoke.

11. A narrow pallet transporting device for use with high profile design pallets, the device comprising:
a chassis;
a rocker arm pivotally coupled to the chassis, wherein the rocker arm is movable between raised position and a lowered position;
a first tine coupled to the chassis, wherein the first tine comprises a first wheel well;
a first proximal wheel yoke movable between a retracted position and an extended position, wherein the first proximal wheel yoke is pivotally coupled to the first tine, wherein the first proximal wheel yoke comprises a first retractable load bearing wheel, and wherein the first retractable load bearing wheel is received within the first wheel well when the first proximal wheel yoke is in the retracted position;
a first distal wheel yoke movable between a retracted position and an extended position, wherein the first distal wheel yoke is pivotally coupled to the first tine, and wherein the first distal wheel yoke comprises a first retractable counter balance wheel;
a first tappet movably coupled to the first tine, wherein the first tappet is pivotally coupled to the first proximal wheel yoke, to the first distal wheel yoke, and to the rocker arm;
a second tine coupled to the chassis, wherein the second tine comprises a second wheel well;
a second proximal wheel yoke movable between a retracted position and an extended position, wherein the second proximal wheel yoke is pivotally coupled to the second tine, wherein the second proximal wheel yoke comprises a second retractable load bearing wheel, and wherein the second retractable load bearing wheel is received within the second wheel well when the second proximal wheel yoke is in the retracted position;
a second distal wheel yoke movable between a retracted position and an extended position, wherein the second distal wheel yoke is pivotally coupled to the second tine, wherein the second distal wheel yoke comprises a second retractable counter balance wheel; and
a second tappet movably coupled to the second tine, wherein the second tappet is pivotally coupled to the second proximal wheel yoke, to the second distal wheel yoke, and to the rocker arm.

12. The device of claim 11, wherein the first proximal wheel yoke, first distal wheel yoke, second proximal wheel yoke, and second distal wheel yoke are moved into the retracted position when the rocker arm is moved into the raised position; and wherein the first proximal wheel yoke, first distal wheel yoke, second proximal wheel yoke, and second distal wheel yoke are moved into the extended position when the rocker arm is moved into the lowered position.

13. The device of claim 11, further comprising a fork tine handle, wherein the fork tine handle is removably coupled to the first tine and second tine.

14. The device of claim 11, further comprising a first horizontal retractable wheel and second horizontal retractable wheel.

15. The device of claim 14, wherein the first horizontal retractable wheel is movable between a first inner position and a second lateral extended position, and wherein the second horizontal retractable wheel is movable between a first inner position and a second lateral extended position.

16. The device of claim 14, further comprising a horizontal retractable caster spring, wherein the first horizontal retractable wheel is movable between a first inner position and a second lateral extended position, wherein the second horizontal retractable wheel is movable between a first inner position and a second lateral extended position, and wherein the horizontal retractable caster spring is operable to position the both the first and second horizontal retractable wheels between a first inner position and a second lateral extended position.

17. The device of claim 11, wherein the first retractable counter balance wheel is a first retractable multi-directional counter balance wheel, and wherein the second retractable counter balance wheel is a second retractable multi-directional counter balance wheel.

18. The device of claim 11, comprising a hydraulic pump operably coupled to the rocker arm.

19. The device of claim 18, wherein the hydraulic pump is an electrically operated hydraulic pump.

20. The device of claim 11, wherein the first proximal wheel yoke is coupled to the first tine medially between the chassis and the first distal wheel yoke, and wherein the second proximal wheel yoke is coupled to the second tine medially between the chassis and the second distal wheel yoke.
